(19) United States
(12) Patent Application Publication
(10) Pub. No.: US 2025/0369475 A1
(43) Pub. Date: Dec. 4, 2025

(54) CONNECTING MECHANISM FOR ADJUSTABLE BED FRAME AND ADJUSTABLE BED FRAME

(71) Applicant: ZINUS INC., Seongnam-si, Gyeonggi-do (KR)

(72) Inventors: Youngdo JUNG, Seongnarn-si (KR); Doohwan CHA, Seangnanrsi (KR)

(21) Appl. No.: 18/874,603

(22) PCT Filed: Jun. 20, 2023
(86) PCT No.: PCT/CN2023/101360

§ 371 Date: Dec. 13, 2024

(30) Foreign Application Priority Data
Jun. 22, 2022 (CN) 202221586401.6

(51) Int. Cl. F16B 12/56; A47C 19/00; A47C 19/04

(52) U.S. Cl. CPC F16B 12/56; A47C 19/005; A47C 19/04

(57) ABSTRACT

A connecting mechanism for an adjustable bed frame and an adjustable bed frame are provided. The connecting mechanism includes a connecting member and a positioning member. The connecting member is provided with a perforation along an axial direction of the connecting member, the perforation is configured for passage of a lateral bar of the adjustable bed frame, the connecting member is provided with a slot in communication with the perforation. The positioning member is adapted to be accommodated in the slot and configured to fix the lateral bar.

### CROSS-REFERENCE TO RELATED APPLICATIONS

This is a national stage of International Application No. PCT/CN2023/101360, filed on Jun. 20, 2023, which claims priority to Chinese Patent Application No. 202221586401.6, filed on Jun. 22, 2022. The disclosures of International Application No. PCT/CN2023/101360 and Chinese Patent Application No. 202221586401.6 are hereby incorporated by reference in their entireties.

### TECHNICAL FIELD

The disclosure relates to the technical field of furniture assembly, and in particular to a connecting mechanism for an adjustable bed frame, and an adjustable bed frame.

### BACKGROUND

In order to meet different use requirements, there are bed frames having different widths. However, it is generally not possible to adjust a width of an existing bed frame according to the use requirements, which makes the use inconvenient. Moreover, the existing bed frame occupies a large space during transportation and storage, which makes the transportation and the storage more troublesome.

In order to solve the above problems and make the width of the bed frame adjustable, in the related art, an adjustable structure includes the following operations. Firstly, the width of the bed frame is adjusted by lateral bars engaged with each other and slidable relative to each other. The lateral bars are fixed to each other by a locking member after the width is adjusted. The lateral bars engaged with each other need to have different dimensions, which affects the strength of the connection at a junction of the lateral bars. Secondly, the lateral bars are slidably connected to each other by a connecting member. Specifically, each of adjacent lateral bars is provided with a support frame in a lateral extension thereof, and is slidably engaged in a respective one of the supporting frames to realize the sliding connection. However, since the adjustable structure has no limit for levels of different dimensions, it is not intuitive for consumers to adjust the width and the consumers may not quickly adjust the width to the required width. In addition, two slidable lateral bars in the related art are usually monolithic and may not be divided into a plurality of sections. The lateral bars may not be freely placed, and a packaging dimension may not be minimized.

### SUMMARY

The disclosure aims to solve at least one of the technical problems in the related art to a certain extent. To this end, an object of the disclosure is to provide a connecting mechanism for an adjustable bed frame. When the connecting mechanism is connected to a lateral bar of the bed frame, a width of the bed frame is conveniently adjusted, and the adjusted width is visible.

A second object of the disclosure is to provide an adjustable bed frame.

In order to achieve the above objects, embodiments of a first aspect of the disclosure provide a connecting mechanism for an adjustable bed frame, which includes a connecting member and a positioning member.

The connecting member is provided with a perforation along an axial direction of the connecting member, and the perforation is configured for passage of a lateral bar of the adjustable bed frame. The connecting member is provided with a slot in communication with the perforation.

The positioning member is adapted to be accommodated in the slot and configured to fix the lateral bar passing through the perforation.

In the connecting mechanism according to the embodiments of the disclosure, when the connecting mechanism is connected to the lateral bar of a bed frame, the lateral bar of the bed frame passes through an axial perforation of the connecting member. The lateral bar is adjusted to the required width. Then, the positioning member is configured to fix the lateral bar passing through the perforation, and the lateral bar is connected to two longitudinal bars to form the bed frame. Therefore, when the connecting mechanism of the disclosure is connected to the lateral bar of the bed frame, a width of the bed frame is conveniently adjusted.

In addition, the connecting mechanism according to the embodiments of the disclosure described above may also have the following additional technical features.

Optionally, the perforation includes a first perforation and a second perforation independent of each other. The lateral bar includes a first lateral bar and a second lateral bar, the first perforation is configured for passage of the first lateral bar, and the second perforation is configured for passage of the second lateral bar.

Specifically, the slot includes a first slot and a second slot, the first slot is in communication with the first perforation, and the second slot is in communication with the second perforation.

Further, the positioning member includes a first positioning member and a second positioning member. The first positioning member is adapted to be accommodated in the first slot to position the first lateral bar that passes through the first perforation, and the second positioning member is adapted to be accommodated in the second slot to position the second lateral bar that passes through the second perforation.

Further, each of the first slot and the second slot is provided as a strip shape, and is arranged along a circumferential direction of the connecting member.

Further, the first perforation is separated from the second perforation by a connecting wall, and the connecting wall is provided with a through hole. The positioning member includes a fixing bar and a mounting bar, the fixing bar is insertable into the slot and adapted to cooperate with a groove of the lateral bar, and the mounting bar passes through the through hole.

Optionally, the positioning member is provided as an L-shaped member and includes a fixing bar and a mounting bar. The fixing bar is insertable into the slot and adapted to cooperate with a groove of the lateral bar, and the mounting bar is connected to the connecting member.

Specifically, a side surface of the connecting member opposite to the slot is provided with a mounting hole, and the mounting bar passes through the mounting hole and extends out of the connecting member. An extending part of the mounting bar that extends out of the connecting member is provided with a limiting structure, and an elastic member is arranged between the limiting structure and the connecting member.

Further, the limiting structure includes a thread arranged on the mounting bar, and a nut connected to the thread. The elastic member is arranged between the nut and the connecting member.

Optionally, the connecting member includes a side surface adjacent to a side of the connecting member provided with the slot, and the side surface of the connecting member is provided with a window in communication with the perforation.

Optionally, an outer wall of a side of the connecting member opposite to a side of the connecting member provided with the slot is provided with a connecting part connected to a supporting leg of the connecting mechanism.

Optionally, the connecting member is a plastic member, and the positioning member is a metal member.

In order to achieve the above objects, embodiments of a second aspect of the disclosure provide an adjustable bed frame, which includes a connecting mechanism for the adjustable bed frame, a lateral bar and two longitudinal bars. The connecting mechanism includes a connecting member and a positioning member. The connecting member is provided with a perforation along an axial direction of the connecting member, and the perforation is configured for passage of the lateral bar of the adjustable bed frame. The connecting member is provided with a slot in communication with the perforation. The positioning member is adapted to be accommodated in the slot and configured to fix the lateral bar passing through the perforation. The lateral bar includes a first lateral bar and a second lateral bar, one end of the first lateral bar is connected to one of the two longitudinal bars, and one end of the second lateral bar is connected to another one of the two longitudinal bars. Another end of the first lateral bar is connected to another end of the second lateral bar by the connecting mechanism.

In the adjustable bed frame according to the embodiments of the disclosure, the adjustable bed frame includes the connecting mechanism. Ends of the first lateral bar and of the second lateral bar of the bed frame, which face one another, pass through an axial perforation of the connecting member. Each of the first lateral bar and the second lateral bar is adjusted to the required width. Then, the positioning member is configured to fix each of the first lateral bar and the second lateral bar that pass through the perforation, and the lateral bar forming the bed frame is connected to the two longitudinal bars to form the bed frame. Therefore, a width of the bed frame is conveniently adjusted.

### BRIEF DESCRIPTION OF THE DRAWINGS

FIG. 1 is a schematic diagram of a connecting mechanism according to an embodiment of the disclosure.

FIG. 2 is a side view of a connecting mechanism according to an embodiment of the disclosure.

FIG. 3 is a cross-sectional view taken along an B-B direction of FIG. 2.

FIG. 4 is a schematic diagram of a connecting member according to an embodiment of the disclosure.

FIG. 5 is another schematic diagram of a connecting member according to an embodiment of the disclosure.

FIG. 6 is a schematic diagram of a lateral bar according to an embodiment of the disclosure.

FIG. 7 is a schematic diagram illustrating a connection of a connecting mechanism and a lateral bar according to an embodiment of the disclosure.

FIG. 8 is a schematic diagram of a bed frame including a connecting mechanism according to an embodiment of the disclosure.

FIG. 9 is a schematic diagram of another bed frame including a connecting mechanism according to an embodiment of the disclosure.

List of reference symbols: connecting member 1, perforation 11, first perforation 111, second perforation 112, connecting wall 113, through hole 1131, slot 12, first slot 121, second slot 122, mounting hole 13, window 14, connecting part 15, positioning member 2, first positioning member 21, second positioning member 22, fixing bar 23, mounting bar 24, thread 241, nut 242, elastic member 25, lateral bar 3, first lateral bar 31, second lateral bar 32, groove 33, longitudinal bar 4, and supporting leg 5.

### DETAILED DESCRIPTION

Embodiments of the disclosure are described in detail below, examples of the embodiments are shown in the drawings. Herein, the same or similar reference symbols refer to the same or similar elements or elements with the same or similar functions throughout the description. The embodiments described below with reference to the drawings are exemplary and are intended to explain the disclosure, but cannot be understood as limiting the disclosure.

The disclosure discloses a connecting mechanism, and when the connecting mechanism is connected to a lateral bar of a bed frame, the lateral bar of the bed frame passes through an axial perforation of a connecting member. The lateral bar is adjusted to the required width. Then, a positioning member is configured to fix the lateral bar passing through the perforation, and the lateral bar is connected to two longitudinal bars to form the bed frame. Therefore, when the connecting mechanism of the disclosure is connected to the lateral bar of the bed frame, a width of the bed frame is conveniently adjusted.

In order to better understand the technical solutions described above, exemplary embodiments of the disclosure are described in more detail below with reference to the drawings. Although the drawings illustrate the exemplary embodiments of the disclosure, it should be understood that the disclosure may be implemented in various forms, and should not be limited by the embodiments described herein. On the contrary, the purpose of providing these embodiments is to more thoroughly understand the disclosure, and to fully convey the scope of the disclosure to those skilled in the art.

In order to better understand the technical solutions described above, the technical solutions described above will be described in detail below in combination with the drawings and the detailed description.

### First Embodiment

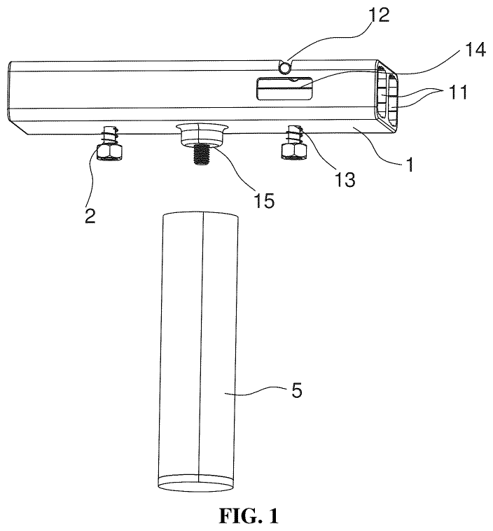

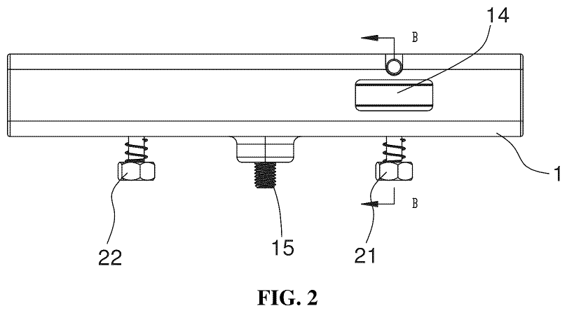

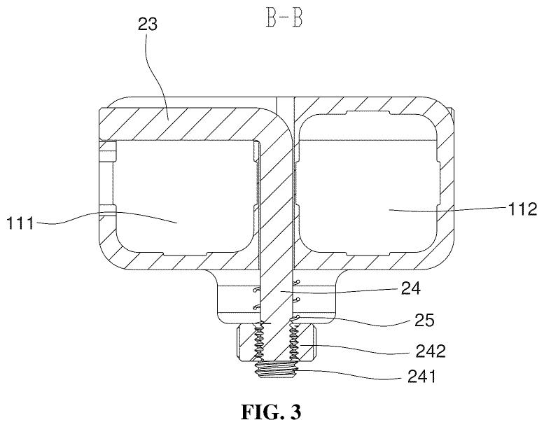

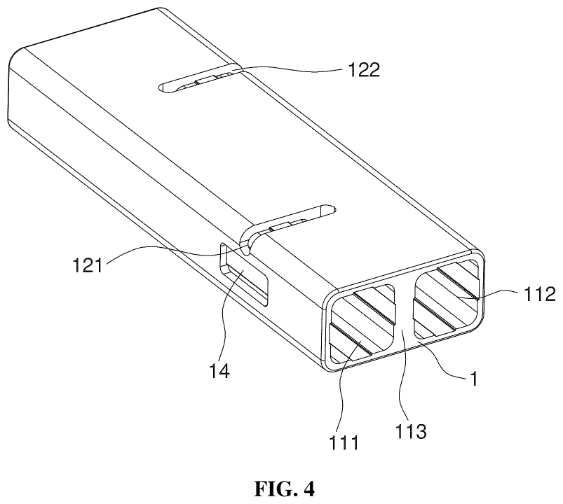

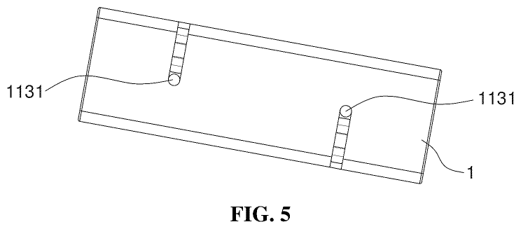

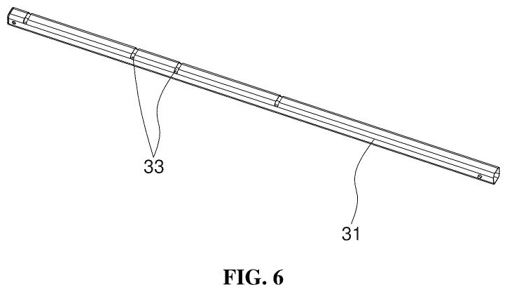

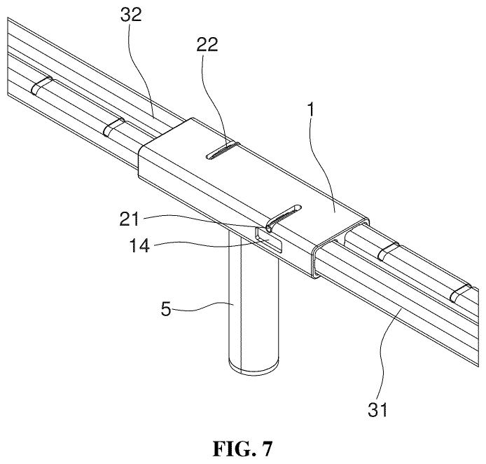

As shown in FIG. 1 to FIG. 9, a connecting mechanism according to embodiments of the disclosure includes a connecting member 1 and a positioning member 2. The connecting member 1 is provided with a perforation 11 along an axial direction of the connecting member 1, and the perforation 11 is configured for passage of a lateral bar 3. The connecting member 1 is provided with a slot 12 in communication with the perforation 11. The positioning member 2 is arranged in the slot 12 and configured to fix the lateral bar 3 passing through the perforation 11.

When the connecting mechanism is connected to the lateral bar 3 of a bed frame, the lateral bar 3 of the bed frame passes through an axial perforation 11 of the connecting member 1. The lateral bar 3 is adjusted to the required width. Then, the positioning member 2 is configured to fix the lateral bar 3 passing through the perforation 11, and the lateral bar 3 is connected to two longitudinal bars 4 to form the bed frame. Therefore, a width of the bed frame is conveniently adjusted.

Optionally, the perforation 11 includes a first perforation 111 and a second perforation 112 independent of each other. The first perforation 111 is separated from the second perforation 112 by a connecting wall 113. Accordingly, the lateral bar 3 includes a first lateral bar 31 and a second lateral bar 32, the first perforation 111 is configured for passage of the first lateral bar 31, and the second perforation 112 is configured for passage of the second lateral bar 32. Accordingly, the slot 12 includes a first slot 121 and a second slot 122, the first slot 121 is in communication with the first perforation 111, and the second slot 122 is in communication with the second perforation 112. Further, each of the first slot 121 and the second slot 122 is provided as a strip shape, and is arranged along a circumferential direction of the connecting member 1, and the first slot 121 is misaligned with the second slot 122. That is, the first slot 121 and the second slot 122 are located on different circumferences. The positioning member 2 includes a first positioning member 21 and a second positioning member 22. The first positioning member 21 is adapted to be accommodated in the first slot 121 to position the first lateral bar 31 that passes through the first perforation 111, and the second positioning member 22 is adapted to be accommodated in the second slot 122 to position the second lateral bar 32 that passes through the second perforation 112.

Specifically, each of the first lateral bar 31 and the second lateral bar 32 is provided with different grooves 33 along a length direction thereof, and the different grooves 33 correspond to different width dimensions. That is, when the positioning member 2 is snapped into the different grooves 33 of each of the first lateral bar 31 and the second lateral bar 32, a bed frame having the different width dimensions, such as four dimensions of T, F, Q and K, is formed. Corresponding dimension labels may be arranged at the different grooves 33 of each of the first lateral bar 31 and the second lateral bar 32.

Optionally, the positioning member 2 is provided as an L-shaped member and includes a fixing bar 23 and a mounting bar 24. The fixing bar 23 is insertable into the slot 12 and adapted to cooperate with a groove 33 of each of the first lateral bar 31 and the second lateral bar 32, and the mounting bar 24 is arranged on the connecting member 1. Specifically, the connecting wall 113 is provided with a through hole 1131, and the mounting bar 24 passes through the through hole 1131 and is connected to the connecting member 1. A side surface of the connecting member 1 opposite to the slot 12 is provided with a mounting hole 13, and the mounting bar 24 passes through the mounting hole 13 and extends out of the connecting member 1. An extending part of the mounting bar 24 that extends out of the connecting member 1 is provided with a limiting structure, and an elastic member 25 is arranged between the limiting structure and the connecting member 1. The elastic member 25 may be a compression spring. The limiting structure includes a thread 241 arranged on the mounting bar 24, and a nut 242 connected to the thread 241. The elastic member 25 is arranged between the nut 242 and the connecting member 1.

When a position in which each of the first lateral bar 31 and the second lateral bar 32 is connected to the connecting member 1 is adjusted, the mounting bar 24 is moved to allow the elastic member 25 to be compressed, to allow the fixing bar 23 to be disengaged from the groove 33 of each of the first lateral bar 31 and the second lateral bar 32. At this time, a connecting end of each of the first lateral bar 31 and the second lateral bar 32 connected to the connecting member 1 may be moved, and when the connecting end is moved to a position corresponding to a target width, the fixing bar 23 is re-snapped into a groove 33 of each of the first lateral bar 31 and the second lateral bar 32 for fixation under an elastic return action of the elastic member 25. In addition, when the fixing bar 23 is disengaged from the groove 33 of each of the first lateral bar 31 and the second lateral bar 32, the first lateral bar 31 and the second lateral bar 32 may be completely disengaged from the connecting member 1. In this way, when the bed frame is packaged, the first lateral bar 31 and the second lateral bar 32 may be freely placed, and a packaging dimension may be minimized as much as possible.

Optionally, the connecting member 1 includes a side surface adjacent to a side of the connecting member 1 provided with the slot 12, and the side surface of the connecting member 1 is provided with a window 14 in communication with the perforation 11. A width dimension label corresponding to the groove 33 of each of the first lateral bar 31 and the second lateral bar 32 may be clearly showed through the window 14. An outer wall of a side of the connecting member 1 opposite to a side of the connecting member provided with the slot 12 is provided with a connecting part 15 connected to a supporting leg 5 of the connecting mechanism, and the supporting leg 5 is located at a middle position of the connecting member 1. Since the supporting leg 5 is directly connected to the connecting member 1, the supporting leg 5 is always located at the middle position without being offset, regardless of a dimension level to which each of the first lateral bar 31 and the second lateral bar 32 is adjusted. In this way, the supporting capacity and the stability are better.

Optionally, the connecting member 1 is a plastic member to facilitate the production and reduce the cost. The positioning member 2 is a metal member and cooperates with a metal lateral bar 3.

### Second Embodiment

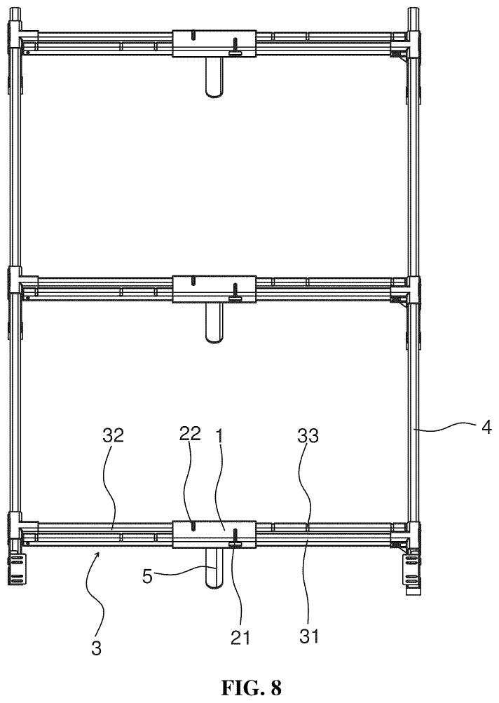

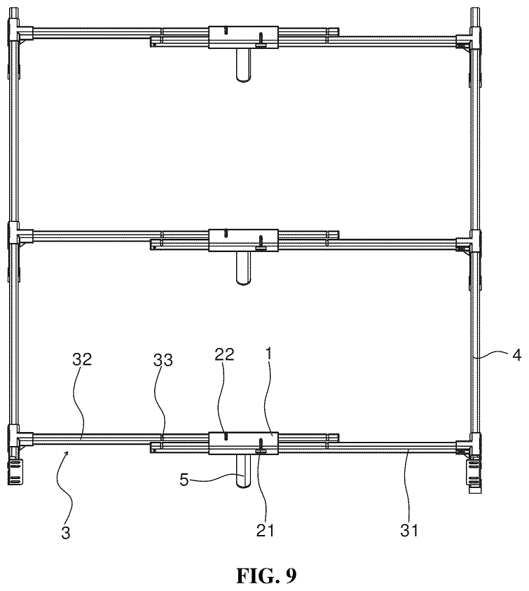

As shown in FIG. 8 and FIG. 9, referring to FIG. 1 to FIG. 7, an adjustable bed frame according to embodiments of the disclosure includes the connecting mechanism, a lateral bar 3 and two longitudinal bars 4. The lateral bar 3 includes a first lateral bar 31 and a second lateral bar 32, one end of the first lateral bar 31 is connected to one of the two longitudinal bars 4, and one end of the second lateral bar 32 is connected to another one of the two longitudinal bars 4. Another end of the first lateral bar 31 is connected to another end of the second lateral bar 32 by the connecting mechanism.

The connecting mechanism includes a connecting member 1 and a positioning member 2. The connecting member 1 is provided with a perforation 11 along an axial direction of the connecting member 1, and the perforation 11 is configured for passage of the first lateral bar 31 and the second lateral bar 32. The connecting member 1 is provided with a slot 12 in communication with the perforation 11. The positioning member 2 is arranged in the slot 12 and configured to fix the first lateral bar 31 and the second lateral bar 32 passing through the perforation 11.

Since the adjustable bed frame includes the connecting mechanism, ends of the first lateral bar 31 and of the second lateral bar 32 of the bed frame, which face one another, pass through an axial perforation 11 of the connecting member 1. Each of the first lateral bar 31 and the second lateral bar 32 is adjusted to the required width. Then, the positioning member 2 is configured to fix each of the first lateral bar 31 and the second lateral bar 32 passing through the perforation 11, and the lateral bar 3 forming the bed frame is connected to the two longitudinal bars 4 to form the bed frame. Therefore, a width of the bed frame is conveniently adjusted.

Optionally, the perforation 11 includes a first perforation 111 and a second perforation 112 independent of each other. The first perforation 111 is separated from the second perforation 112 by a connecting wall 113. Accordingly, the lateral bar 3 includes a first lateral bar 31 and a second lateral bar 32, the first perforation 111 is configured for passage of the first lateral bar 31, and the second perforation 112 is configured for passage of the second lateral bar 32. Accordingly, the slot 12 includes a first slot 121 and a second slot 122, the first slot 121 is in communication with the first perforation 111, and the second slot 122 is in communication with the second perforation 112. Further, each of the first slot 121 and the second slot 122 is provided as a strip shape, and is arranged along a circumferential direction of the connecting member 1, and the first slot 121 is misaligned with the second slot 122. That is, the first slot 121 and the second slot 122 are located on different circumferences. The positioning member 2 includes a first positioning member 21 and a second positioning member 22. The first positioning member 21 is adapted to be accommodated in the first slot 121 to position the first lateral bar 31 that passes through the first perforation 111, and the second positioning member 22 is adapted to be accommodated in the second slot 122 to position the second lateral bar 32 that passes through the second perforation 112.

Specifically, each of the first lateral bar 31 and the second lateral bar 32 is provided with different grooves 33 along a length direction thereof, and the different grooves 33 correspond to different width dimensions. That is, when the positioning member 2 is snapped into the different grooves 33 of each of the first lateral bar 31 and the second lateral bar 32, a bed frame having the different width dimensions, such as four dimensions of T, F, Q and K, is formed. Corresponding dimension labels may be arranged at the different grooves 33 of each of the first lateral bar 31 and the second lateral bar 32.

Optionally, the positioning member 2 is provided as an L-shaped member and includes a fixing bar 23 and a mounting bar 24. The fixing bar 23 is insertable into the slot 12 and adapted to cooperate with a groove 33 of each of the first lateral bar 31 and the second lateral bar 32, and the mounting bar 24 is arranged on the connecting member 1. Specifically, the connecting wall 113 is provided with a through hole 1131, and the mounting bar 24 passes through the through hole 1131 and is connected to the connecting member 1. A side surface of the connecting member 1 opposite to the slot 12 is provided with a mounting hole 13, and the mounting bar 24 passes through the mounting hole 13 and extends out of the connecting member 1. An extending part of the mounting bar 24 that extends out of the connecting member 1 is provided with a limiting structure, and an elastic member 25 is arranged between the limiting structure and the connecting member 1. The elastic member 25 may be a compression spring. The limiting structure includes a thread 241 arranged on the mounting bar 24, and a nut 242 connected to the thread 241. The elastic member 25 is arranged between the nut 242 and the connecting member 1.

When a position in which each of the first lateral bar 31 and the second lateral bar 32 is connected to the connecting member 1 is adjusted, the mounting bar 24 is moved to allow the elastic member 25 to be compressed, to allow the fixing bar 23 to be disengaged from the groove 33 of each of the first lateral bar 31 and the second lateral bar 32. At this time, a connecting end of each of the first lateral bar 31 and the second lateral bar 32 connected to the connecting member 1 may be moved, and when the connecting end is moved to a position corresponding to a target width, the fixing bar 23 is re-snapped into the groove 33 of each of the first lateral bar 31 and the second lateral bar 32 for fixation under an elastic return action of the elastic member 25. In addition, when the fixing bar 23 is disengaged from the groove 33 of each of the first lateral bar 31 and the second lateral bar 32, the first lateral bar 31 and the second lateral bar 32 may be completely disengaged from the connecting member 1. In this way, when the bed frame is packaged, the first lateral bar 31 and the second lateral bar 32 may be freely placed, and a packaging dimension may be minimized as much as possible.

Optionally, the connecting member 1 includes a side surface adjacent to a side of the connecting member 1 provided with the slot 12, and the side surface of the connecting member 1 is provided with a window 14 in communication with the perforation 11. A width dimension label corresponding to the groove 33 of each of the first lateral bar 31 and the second lateral bar 32 may be clearly showed through the window 14. An outer wall of a side of the connecting member 1 opposite to a side of the connecting member provided with the slot 12 is provided with a connecting part 15 connected to a supporting leg 5 of the connecting mechanism, and the supporting leg 5 is located at a middle position of the connecting member 1. Since the supporting leg 5 is directly connected to the connecting member 1, the supporting leg 5 is always located at the middle position without being offset, regardless of a dimension level to which each of the first lateral bar 31 and the second lateral bar 32 is adjusted. In this way, the supporting capacity and the stability are better.

Optionally, the connecting member 1 is a plastic member to facilitate the production and reduce the cost. The positioning member 2 is a metal member and cooperates with a metal lateral bar 3.

In the description of the disclosure, it should be understood that the orientation or positional relationship indicated by the terms “center”, “longitudinal”, “lateral”, “length”, “width”, “thickness”, “upper”, “lower”, “front”, “back”, “left”, “right”, “vertical”, “horizontal”, “top”, “bottom”, “inner”, “outer”, “clockwise”, “counterclockwise” or the like is based on an orientation or positional relationship shown in the drawings. These terms are intended solely for ease of describing the disclosure and simplifying the description, and are not intended to indicate or imply that the devices or elements must have a particular orientation, be constructed and operated in a particular orientation. In this way, these orientation terms are not to be understood as limiting the disclosure.

Furthermore, the terms “first” and “second” are only for purposes of description, and are not to be understood as indicating or implying relative importance or implicitly indicating the number of technical features indicated. Thus, the features defined as “first” and “second” may explicitly or implicitly include one or more of the features. In the description of the disclosure, the meaning of “a plurality of” is two or more, unless expressly defined and specified otherwise.

In the disclosure, unless expressly defined and specified otherwise, the terms “mounted”, “connected”, “connection”, “fixed” or the like should be understood in a broad sense. For example, “connection” may be a fixed connection, a detachable connection, or an integral connection, “connection” may be a mechanical connection or an electrical connection, and “connection” may be a direct connection, an indirect connection through an intermediary, or internal communication of two elements or interaction of two elements. The specific meanings of the above terms in the disclosure may be understood according to the specific situations for those skilled in the art.

In the disclosure, unless expressly defined and specified otherwise, the expression that a first feature is “above” or “below” a second feature may include the fact that the first feature is in direct contact with the second feature, or may include the fact that the first feature is in no direct contact with the second feature, but is in contact with the second feature by another feature between the first feature and the second feature. In addition, the expression that the first feature is “on”, “above” and “over” the second feature includes the fact that the first feature is directly above and diagonally above the second feature, or only indicates the fact that the first feature is horizontally higher than the second feature. The expression that the first feature is “under”, “below” and “beneath” the second feature includes the fact that the first feature is directly below and diagonally below the second feature, or only indicates the fact that the first feature is horizontally lower than the second feature.

In the description of the disclosure, the description of the terms “one embodiment”, “some embodiments”, “examples”, “specific examples”, “some examples” or the like means that specific features, structures, materials, or characteristics described in combination with the embodiment or example are included in at least one embodiment or example of the disclosure. In the description, the schematic expressions of the above terms should not be understood as necessarily referring to the same embodiments or examples. In addition, the specific features, the structures, the materials, or the characteristics described may be combined in any one or more embodiments or examples in a suitable manner. Furthermore, different embodiments or examples described in the description may be integrated and combined by those skilled in the art.

Although the embodiments of the disclosure are shown and described above, it can be understood that the embodiments described above are exemplary and cannot be understood as limiting the disclosure. Those skilled in the art may make changes, modifications, substitutions and variations to the embodiments described above within the scope of the disclosure.

1. A connecting mechanism for an adjustable bed frame, comprising:
a connecting member, the connecting member being provided with a perforation along an axial direction of the connecting member, the perforation being configured for passage of a lateral bar of the adjustable bed frame, the connecting member being provided with a slot in communication with the perforation; and
a positioning member, the positioning member being adapted to be accommodated in the slot and configured to fix the lateral bar passing through the perforation.

2. The connecting mechanism for the adjustable bed frame according to claim 1, wherein the perforation comprises a first perforation and a second perforation independent of each other, the lateral bar comprises a first lateral bar and a second lateral bar, the first perforation is configured for passage of the first lateral bar, and the second perforation is configured for passage of the second lateral bar.

3. The connecting mechanism for the adjustable bed frame according to claim 2, wherein the slot comprises a first slot and a second slot, the first slot is in communication with the first perforation, and the second slot is in communication with the second perforation.

4. The connecting mechanism for the adjustable bed frame according to claim 3, wherein the positioning member comprises a first positioning member and a second positioning member, the first positioning member is adapted to be accommodated in the first slot to position the first lateral bar that passes through the first perforation, and the second positioning member is adapted to be accommodated in the second slot to position the second lateral bar that passes through the second perforation.

5. The connecting mechanism for the adjustable bed frame according to claim 3, wherein each of the first slot and the second slot is provided as a strip shape, and is arranged along a circumferential direction of the connecting member.

6. The connecting mechanism for the adjustable bed frame according to claim 2, wherein the first perforation is separated from the second perforation by a connecting wall, the connecting wall is provided with a through hole, the positioning member comprises a fixing bar and a mounting bar, the fixing bar is insertable into the slot and adapted to cooperate with a groove of the lateral bar, and the mounting bar passes through the through hole.

7. The connecting mechanism for the adjustable bed frame according to claim 1, wherein the positioning member is provided as an L-shaped member and comprises a fixing bar and a mounting bar, the fixing bar is insertable into the slot and adapted to cooperate with a groove of the lateral bar, and the mounting bar is connected to the connecting member.

8. The connecting mechanism for the adjustable bed frame according to claim 7, wherein a side surface of the connecting member opposite to the slot is provided with a mounting hole, the mounting bar passes through the mounting hole and extends out of the connecting member, an extending part of the mounting bar that extends out of the connecting member is provided with a limiting structure, and an elastic member is arranged between the limiting structure and the connecting member.

9. The connecting mechanism for the adjustable bed frame according to claim 8, wherein the limiting structure comprises a thread arranged on the mounting bar, and a nut connected to the thread, and the elastic member is arranged between the nut and the connecting member.

10. The connecting mechanism for the adjustable bed frame according to claim 1, wherein the connecting member comprises a side surface adjacent to a side of the connecting member provided with the slot, and the side surface of the connecting member is provided with a window in communication with the perforation.

11. The connecting mechanism for the adjustable bed frame according to claim 1, wherein an outer wall of a side of the connecting member opposite to a side of the connecting member provided with the slot is provided with a connecting part connected to a supporting leg of the connecting mechanism.

12. The connecting mechanism for the adjustable bed frame according to claim 1, wherein the connecting member is a plastic member, and the positioning member is a metal member.

13. An adjustable bed frame, comprising a connecting mechanism for the adjustable bed frame, a lateral bar and two longitudinal bars, wherein the connecting mechanism comprises:
a connecting member, the connecting member being provided with a perforation along an axial direction of the connecting member, the perforation being configured for passage of the lateral bar of the adjustable bed frame, the connecting member being provided with a slot in communication with the perforation; and
a positioning member, the positioning member being adapted to be accommodated in the slot and configured to fix the lateral bar passing through the perforation,
wherein the lateral bar comprises a first lateral bar and a second lateral bar, one end of the first lateral bar is connected to one of the two longitudinal bars, one end of the second lateral bar is connected to another one of the two longitudinal bars, and another end of the first lateral bar is connected to another end of the second lateral bar by the connecting mechanism.

14. The adjustable bed frame according to claim 13, wherein the perforation comprises a first perforation and a second perforation independent of each other, the first perforation is configured for passage of the first lateral bar, and the second perforation is configured for passage of the second lateral bar.

15. The adjustable bed frame according to claim 14, wherein the slot comprises a first slot and a second slot, the first slot is in communication with the first perforation, and the second slot is in communication with the second perforation; wherein the positioning member comprises a first positioning member and a second positioning member, the first positioning member is adapted to be accommodated in the first slot to position the first lateral bar that passes through the first perforation, and the second positioning member is adapted to be accommodated in the second slot to position the second lateral bar that passes through the second perforation.

16. The adjustable bed frame according to claim 15, wherein each of the first slot and the second slot is provided as a strip shape, and is arranged along a circumferential direction of the connecting member.

17. The adjustable bed frame according to claim 14, wherein the first perforation is separated from the second perforation by a connecting wall, the connecting wall is provided with a through hole, the positioning member comprises a fixing bar and a mounting bar, the fixing bar is insertable into the slot and adapted to cooperate with a groove of the lateral bar, and the mounting bar passes through the through hole.

18. The adjustable bed frame according to claim 13, wherein the positioning member is provided as an L-shaped member and comprises a fixing bar and a mounting bar, the fixing bar is insertable into the slot and adapted to cooperate with a groove of the lateral bar, and the mounting bar is connected to the connecting member.

19. The adjustable bed frame according to claim 18, wherein a side surface of the connecting member opposite to the slot is provided with a mounting hole, the mounting bar passes through the mounting hole and extends out of the connecting member, an extending part of the mounting bar that extends out of the connecting member is provided with a limiting structure, and an elastic member is arranged between the limiting structure and the connecting member.

20. The adjustable bed frame according to claim 13, wherein the connecting member comprises a side surface adjacent to a side of the connecting member provided with the slot, and the side surface of the connecting member is provided with a window in communication with the perforation.
